(19) United States
(12) Patent Application Publication
(10) Pub. No.: US 2013/0297380 A1
(43) Pub. Date: Nov. 7, 2013

(54) INVENTORY ADJUSTMENT BASED ON SOCIAL NETWORK DATA

(71) Applicant: Sandra Lynn Godsey, San Jose, CA (US)

(72) Inventor: Sandra Lynn Godsey, San Jose, CA (US)

(73) Assignee: eBay Inc., San Jose, CA (US)

(21) Appl. No.: 13/462,056

(22) Filed: May 2, 2012

(51) Int. Cl. G06Q 10/08; G06Q 10/04

(52) U.S. Cl. 705/7.31

(57) ABSTRACT

Social network data may be accessed by an inventory adjustment machine, and such social network data may be accessed from one or more social network servers. The social network data may be accessed in the form of user submissions published by one or more social network services. The inventory adjustment machine may identify a topical trend from accessed user submissions. The inventory adjustment machine may determine that a product available for sale corresponds to the topical trend identified from the user submissions. After determining that the product corresponds the topical trend, the inventory adjustment machine may adjust a value that represents a quantity of the product within an inventory that includes the product. This adjustment of the value may be based on the topical trend identified from the user submissions accessed from the one or more social network servers.

### TECHNICAL FIELD

The subject matter disclosed herein generally relates to the processing of data. Specifically, the present disclosure addresses systems and methods of inventory adjustment based on social network data.

### BACKGROUND

One or more social network services may be provided by one or more social network servers. A social network service may allow users of the social network service to communicate with each other by communicating with the social network server that supports the social network service. For example, a user may send a comment from a device of the user (e.g., a computer or smart phone) to a social network server (e.g., a computer) that provides all or part of a social network service, and the social network server may publish the comment on a webpage that corresponds to the user, where the webpage is accessible by members of the user's social network (e.g., friends, followers, or connections of the user). As another example, several users may send their ratings of an item or document to the social network server, and the social network server may aggregate the ratings and publish a tally of the ratings for the item or document.

### BRIEF DESCRIPTION OF THE DRAWINGS

Some embodiments are illustrated by way of example and not limitation in the figures of the accompanying drawings.

FIG. 1 is a network diagram illustrating a network environment suitable for inventory adjustment based on social network data, according to some example embodiments.

FIG. 2-3 are line charts illustrating interest surges within total user submissions, according to some example embodiments.

FIG. 4 is a block diagram illustrating components of an inventory adjustment machine suitable for inventory adjustment based on social network data, according to some example embodiments.

FIG. 5-7 are flowcharts illustrating operations of the inventory adjustment machine in performing a method of inventory adjustment based on social network data, according to some example embodiments.

FIG. 8 is a block diagram illustrating components of a machine, according to some example embodiments, able to read instructions from a machine-readable medium and perform any one or more of the methodologies discussed herein.

### DETAILED DESCRIPTION

Example methods and systems are directed to inventory adjustment based on social network data. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Social network data may be accessed by a machine (e.g., an inventory adjustment machine), and such social network data may be accessed in the form of user submissions published by one or more social network services. The machine may identify a topical trend from such user submissions accessed from one or more social network servers (e.g., server machines). Functioning as an inventory adjustment machine, the machine may determine that a product (e.g., physical items or goods) available for sale corresponds to the topical trend identified from the user submissions. After determining that the product corresponds the topical trend, the machine may adjust a value (e.g., a scalar value) that represents a quantity of the product within an inventory that includes the product. This adjustment of the value may be based on the topical trend identified from the user submissions accessed from the one or more social network servers.

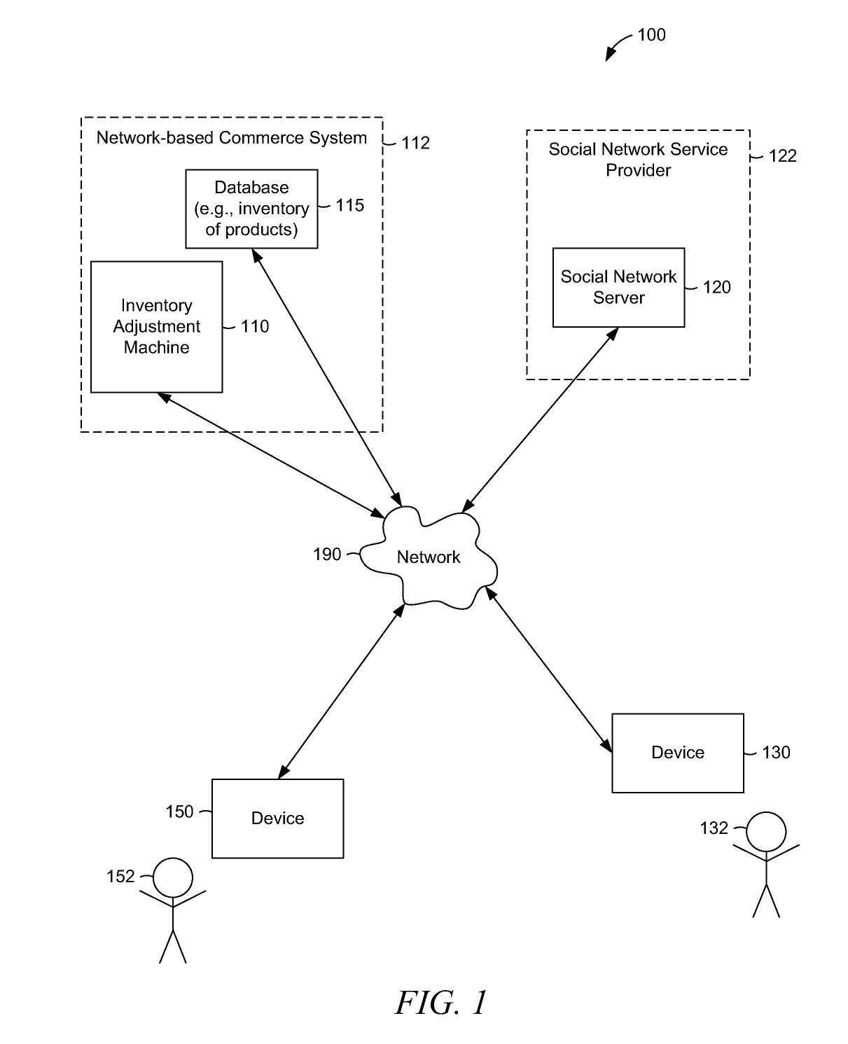

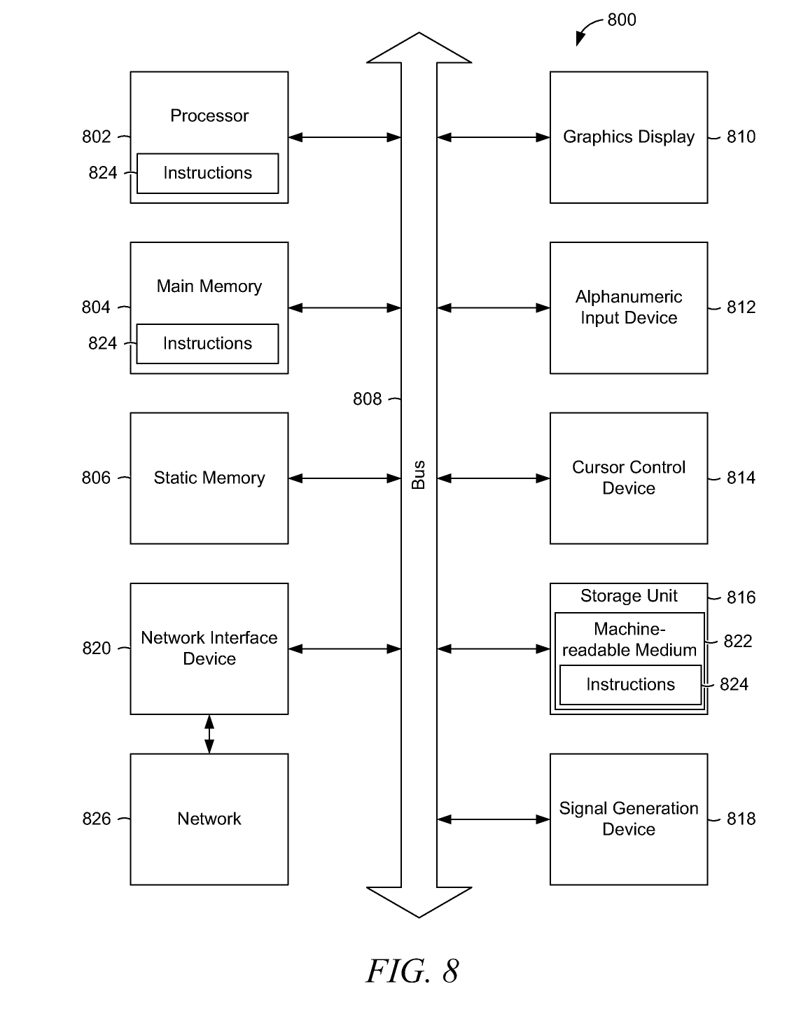

FIG. 1 is a network diagram illustrating a network environment 100 suitable for inventory adjustment based on social network data, according to some example embodiments. The network environment 100 includes an inventory adjustment machine 110, a database 115, a social network server 120, and devices 130 and 150, all communicatively coupled to each other via a network 190. As shown in FIG. 1, the inventory adjustment machine 110, the database 115, or both, may form all or part of a network-based commerce system 112. In a similar fashion, the social network server 120 may form all or part of a social network service provider 122. The database 115 may store an inventory of products (e.g., database records indicating one or more products and one or more respective quantities thereof). The inventory adjustment machine 110, the database 115, the social network server 120, and the devices 130 and 150 may each be implemented in a computer system, in whole or in part, as described below with respect to FIG. 8.

Also shown in FIG. 1 are users 132 and 152. One or both of the users 132 and 152 may be a human user (e.g., a human being), a machine user (e.g., a computer configured by a software program to interact with the device 130), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, or a smart phone belonging to the user 132. Likewise, the user 152 is not part of the network environment 100, but is associated with the device 150. As an example, the device 150 may be a desktop computer, a vehicle computer, a tablet computer, a navigational device, a portable media device, or a smart phone belonging to the user 152.

Any of the machines, databases, or devices shown in FIG. 1 may be implemented in a general-purpose computer modified (e.g., configured or programmed) by software to be a special-purpose computer to perform the functions described herein for that machine. For example, a computer system able to implement any one or more of the methodologies described herein is discussed below with respect to FIG. 8. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines illustrated in FIG. 1 may be combined into a single machine, and the functions described herein for any single machine may be subdivided among multiple machines.

The network 190 may be any network that enables communication between machines (e.g., inventory adjustment machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

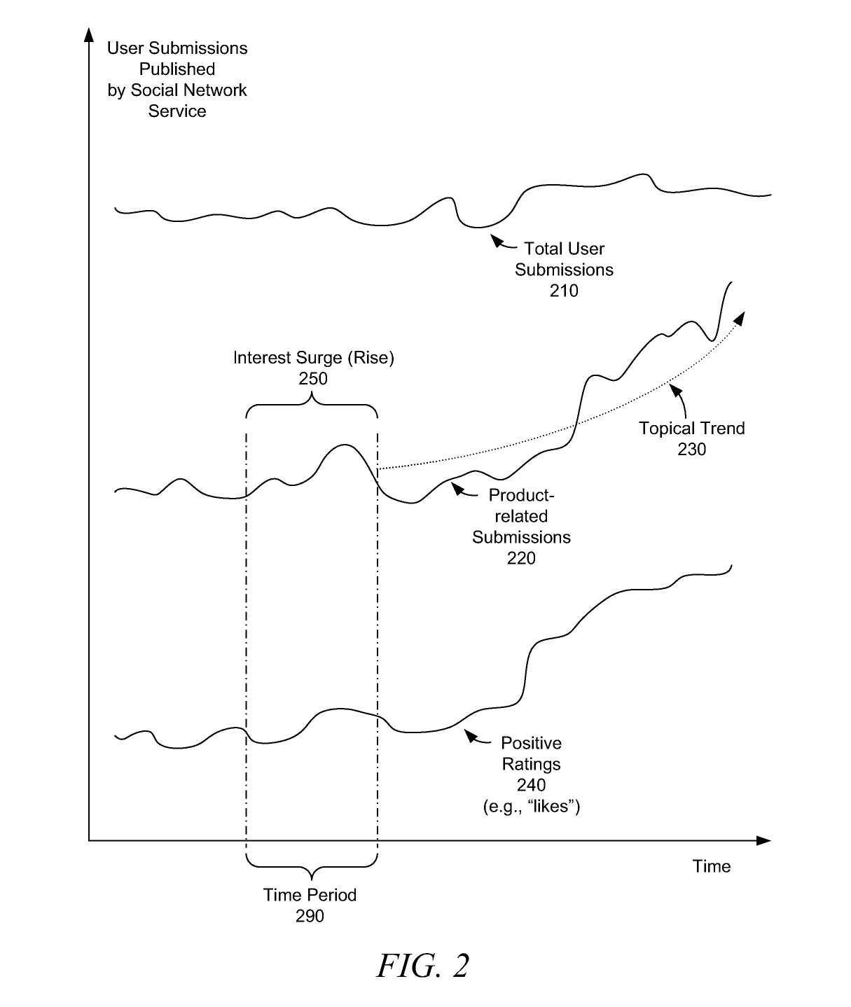

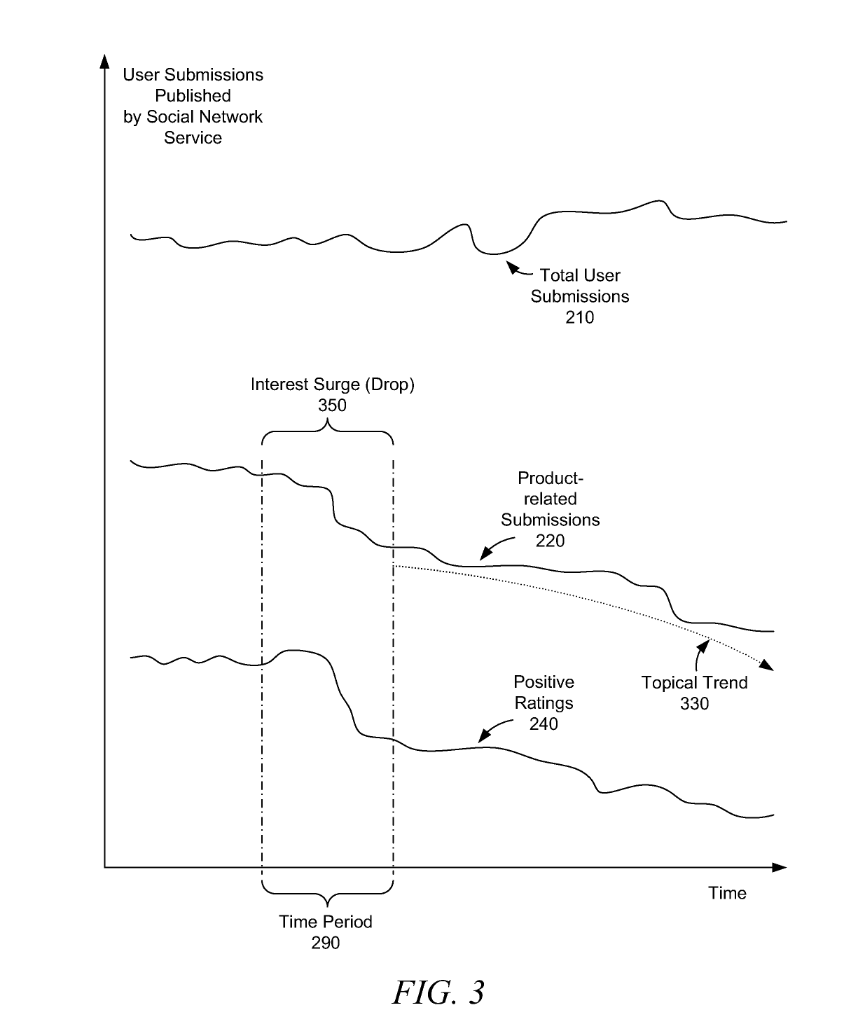

FIG. 2-3 are line charts (e.g., graphs) illustrating surges in interest within total user submissions 210 published by a social network service (e.g., provided by the social network service provider 122), according to some example embodiments. As shown, the vertical axis of the line charts represents user submissions published by the social network service, while the horizontal axis represents time.

Within each of the line charts, the topmost line represents total user submissions 210 per unit of time (e.g., daily, weekly, monthly, or annually). Examples of user submissions among the total user submissions 210 include ratings such as a positive rating (e.g., a “like” indicator, a “thumbs up” flag, or a five-star rating), a negative rating (e.g., a “dislike” indicator, a “thumbs down” flag, or a one-star rating), a neutral rating (e.g., a null indicator, a null flag, or a three-star rating), or any suitable combination thereof. As a user submission, a rating may be indicative of a sentiment by a user toward a ratable object related to a product (e.g., a physical item or good available for sale).

Accordingly, within each of the line charts, the middle line represents product-related submissions 220 (e.g., user submissions that are product-related) per unit of time. Examples of the product-related submissions 220 include ratings of objects that are related to a product. For example, a positive rating may be indicative of a positive sentiment by a user toward a product-related object, and a negative rating may be indicative of a negative sentiment by the user toward the product-related object. Examples of product-related objects include a product webpage that describes the product, a news article that mentions the product, a seller webpage that references (e.g., describes) a seller of the product, a manufacturer webpage that references a manufacturer of the product, a celebrity webpage that associates (e.g., correlates) a celebrity (e.g., a well-known person, character, or group of persons or characters) with the product, or any suitable combination thereof. Additional examples of product-related objects include a comment that references the product, a question that references the product, an answer (e.g., to the question) that references the product, a link to a webpage (e.g., an online document, presentation, article, discussion, or list of frequently asked questions) that references the product, or any suitable combination thereof.

Hence, within each of the line charts, the bottommost line represents positive ratings 240 (e.g., “like” indicators) among the product-related submissions 220 within the total user submissions 210. An example of one of the positive ratings 240 is a “like” indicator that indicates that a user of the social network service (e.g., provided by the social network service provider 122) likes the product (e.g., views the product favorably or has a positive sentiment toward the product). In various example embodiments, such a “like” indicator may be called a “thumbs up” flag or indicator, an up arrow (e.g., “upvote”) flag or indicator, a “favorite” flag or indicator, or any suitable combination thereof. As noted above, the positive ratings 240 may include a five-star rating or some other variant thereof (e.g., eight out of ten smiley faces). In some example embodiments, one or more of the positive ratings 240 may be a numerical score (e.g., 7.5 on a 10 point scale).

As shown in FIG. 2, an interest surge 250 may be represented by a portion of the product-related submissions 220 submitted within a time period 290. In the example shown in FIG. 2, the interest surge 250 may indicate a rise or increase in attention paid by users of the social network service toward the product, as evidenced by an uptick in the product-related submissions 220. Similarly, the interest surge 250 may be represented by a portion of the positive ratings 240 submitted within the time period 290. In the example shown in FIG. 2, the interest surge 250 may indicate a rise or increase in positive sentiments toward the product from the users of the social network service, as evidenced by an uptick in the positive ratings 240.

The inventory adjustment machine 110 may access the total user submissions 210 and analyze the product-related submissions 220, the positive ratings 240, or both. Based on the interest surge 250 (e.g., detected from the product-related submissions 220, the positive ratings 240, or both), the inventory adjustment machine 110 may identify (e.g., calculate, infer, or determine) a topical trend 230. In the example shown in FIG. 2, the topical trend 230 is preceded by the interest surge 250 and indicates a rising or increasing trend in the product-related submissions 220, in the positive ratings 240, or any suitable combination thereof.

As shown in FIG. 3, an interest surge 350 may be represented by a portion of the product-related submissions 220 submitted within the time period 290. In the example shown in FIG. 3, the interest surge 350 may indicate a drop or decrease in attention paid by users of the social network service toward the product, as evidenced by a downturn in the product-related submissions 220. Similarly, the interest surge 350 may be represented by a portion of the positive ratings 240 submitted within the time period 290. In the example shown in FIG. 2, the interest surge 350 may indicate a drop or decrease in positive sentiments toward the product from the users of the social network service, as evidenced by a downturn in the positive ratings 240.

Based on the interest surge 350 (e.g., detected from the product-related submissions 220, the positive ratings 240, or both), the inventory adjustment machine 110 may identify a topical trend 330. In the example shown in FIG. 3, the topical trend 330 is preceded by the interest surge 350 and indicates a falling or decreasing trend in the product-related submissions 220, in the positive ratings 240, or any suitable combination thereof.

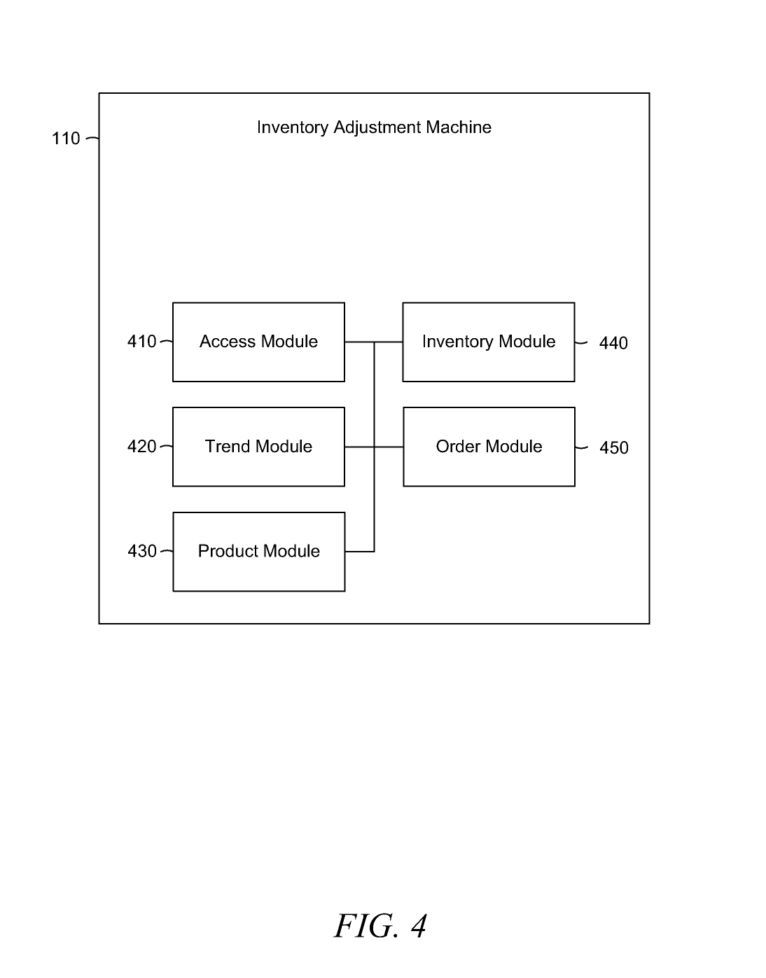

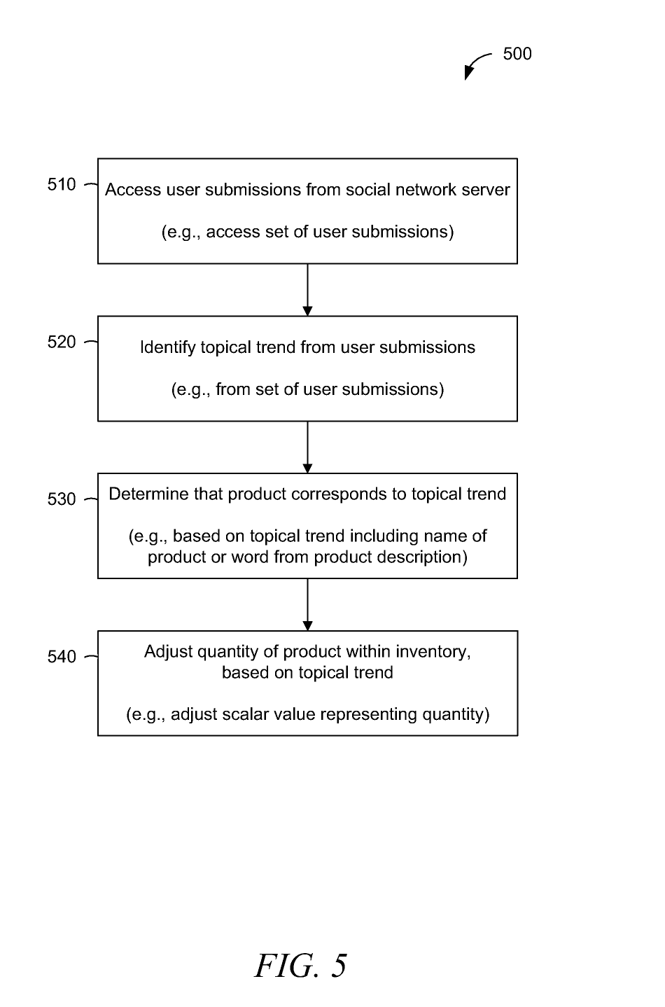

FIG. 4 is a block diagram illustrating components of the inventory adjustment machine 110, which may be configured to perform inventory adjustment based on social network data (e.g., some or all of the total user submissions 210), according to some example embodiments. The inventory adjustment machine 110 includes an access module 410, a trend module 420, a product module 430, and an inventory module 440, all configured to communicate with each other (e.g., via a bus, shared memory, or a switch). In some example embodiments, the inventory adjustment machine 110 also includes an order module 450, similarly configured to communicate with the other modules in the inventory adjustment machine 110. The functions of these modules are described below with respect to FIG. 5-7.

Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules.

FIG. 5-7 are flowcharts illustrating operations of the inventory adjustment machine 110 in performing a method 500 of inventory adjustment based on social network data (e.g., some or all of the product-related submissions 220), according to some example embodiments. Operations in the method 500 may be performed by the inventory adjustment machine 110, using modules described above with respect to FIG. 4. As shown in FIG. 5, the method 500 includes operations 510, 520, 530, and 540.

In operation 510, the access module 410 accesses user submissions (e.g., total user submissions 210) from the social network server 120. For example, the access module 410 may access a set (e.g., group or batch) of user submissions that have been aggregated over a period of time (e.g., time period 290 of the previous three years). The social network server 120 may provide at least part of the social network service used by users who submitted the user submissions accessed in operation 510.

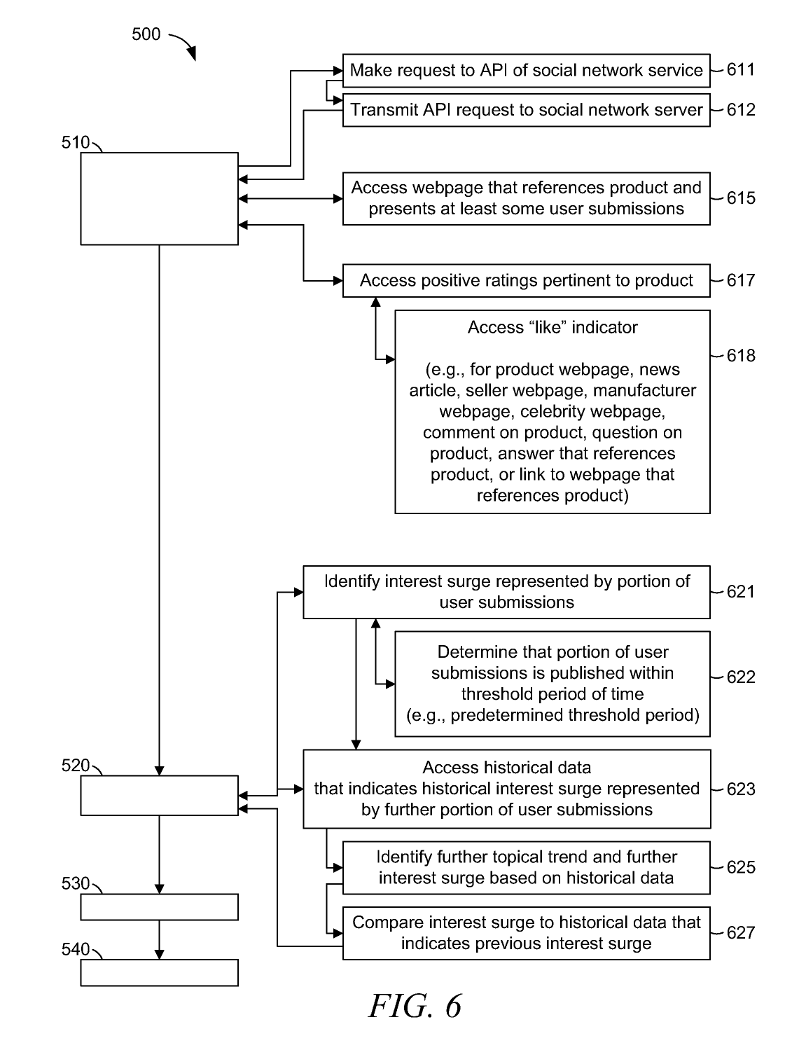

In operation 520, a trend module 420 identifies a topical trend (e.g., topical trend 230 or topical trend 330) based on (e.g., from) the user submissions accessed from the social network server 120 in operation 510. Further details of operation 520 are discussed below with respect to FIG. 6.

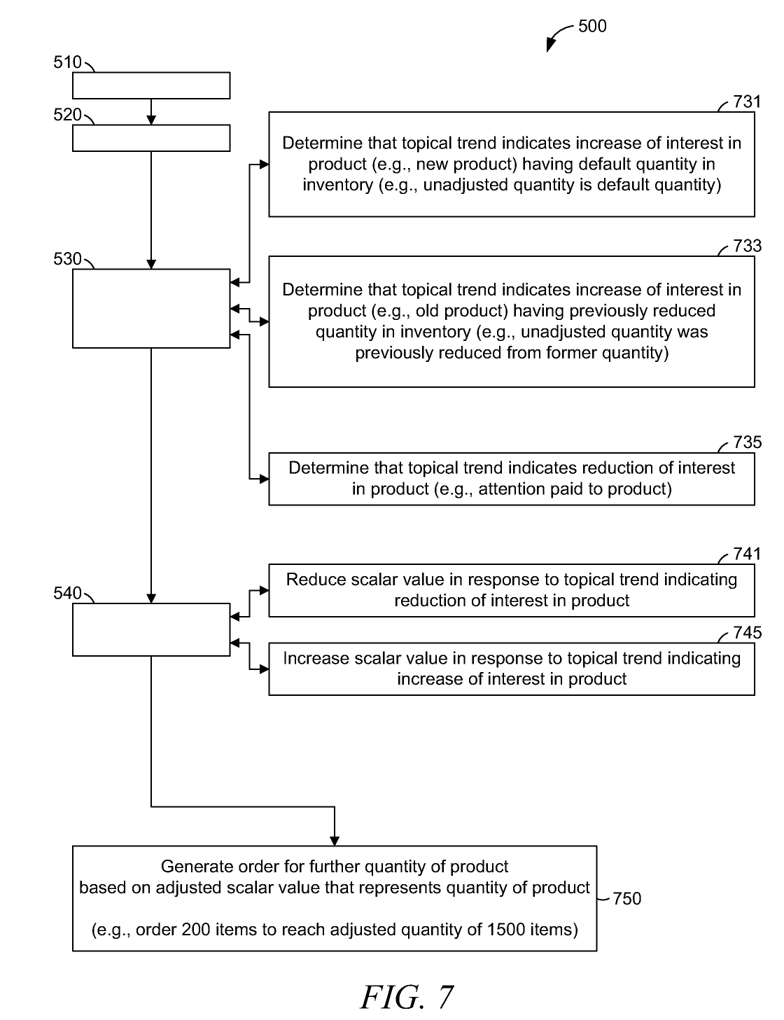

In operation 530, the product module 430 determines that a product corresponds to the topical trend identified in operation 520 from the user submissions accessed from the social network server 120 in operation 510. Further details of operation 530 are discussed below with respect to FIG. 7.

In operation 540, the inventory module 440 adjusts (e.g., modifies, overwrites, or alters) a value that represents a quantity of the product (e.g., determined in operation 530 as corresponding to the topical trend) within an inventory that includes the product. The value may be a scalar value (e.g., an integer value or a floating-point value), and the value may be stored in the database 115 (e.g., within a database record that corresponds to the product). The inventory module 440 may adjust the value based on the topical trend identified in operation 520 from the user submissions accessed from the social network server 120 in operation 510. Further details of operation 540 are discussed below with respect to FIG. 7.

As shown in FIG. 6, the method 500 may include one or more of operations 611, 612, 615, 617, 618, 621, 622, 623, 625, and 627. One or more of operations 611, 612, 615, and 617 may be performed as part (e.g., a precursor task, a subroutine, or a portion) of operation 510, in which the access module 410 accesses the user submissions (e.g., total user submissions 210).

In operation 611, the access module 410 makes a request (e.g., a call) to an application programming interface (API) of the social network service provided by the social network service provider 122. Accordingly, the social network server 120 may be configured to receive such requests and respond to such requests. As an example, the request may be a request for access to some or all of the user submissions available from the social network server 120 (e.g., some or all of the total user submissions 210).

In operation 612, the access module 410 transmits the request (e.g., the call) to the social network server 120, which may be configured to receive and respond to the request. In some example embodiments, the social network server 120 responds to the request by providing the access module 410 with access to the user submissions discussed above with respect to operation 510. Accordingly, the access module 410 may perform operation 510 by reading or retrieving user submissions from the social network server 120.

In operation 615, the access module 410 accesses a webpage. The accessed webpage may reference the product and may present at least some of the user submissions discussed above with respect to operation 510. For example, the product may be a digital camera, and the webpage may describe the digital camera and present one or more user-submitted ratings of the digital camera (e.g., “like” indicators). Such a webpage may be generated and hosted by a seller of the product, a manufacturer of the product, a reviewer of the product, or any suitable combination thereof. In accessing the web page, the access module 410 may read or retrieve one or more user-submitted ratings as some or all of the user submissions accessed in operation 510.

In operation 617, the access module 410 accesses positive ratings (e.g., some or all of the positive ratings 240) that are pertinent to the product. For example, the access module 410 may access one or more “like” indicators or flags, “thumbs up” indicators or flags, “upvote” indicators or flags, five-star ratings, four-star ratings, or any suitable combination thereof, with respect to the product. As noted above, a positive rating may be indicative of a positive sentiment (e.g., by the user 132) toward a product webpage that describes the product, a news article that mentions the product, a seller webpage that references a seller of the product, a manufacturer webpage that references a manufacturer of the product, a celebrity webpage that associates a celebrity with the product, or any suitable combination thereof. Moreover, a positive rating may be indicative of a positive sentiment (e.g., by the user 152) toward a comment that references the product, a question that references the product, an answer (e.g., to the question) that references the product, a link to a webpage (e.g., an online document, presentation, article, discussion, or list of frequently asked questions) that references the product, or any suitable combination thereof.

Operation 618 may be performed as part (e.g., a precursor task, a subroutine, or a portion) of operation 617, in which the access module 410 accesses positive ratings that are pertinent to the product. In operation 618, the access module 410 accesses a “like” indicator that indicates that a user of the social network service (e.g., provided by the social network service provider 122) likes the product.

One or more of operations 621, 623, 625, and 627 may be performed as part of operation 520, in which the trend module 420 identifies a topical trend (e.g., topical trend 230 or topical trend 330). In operation 621, the trend module 420 identifies an interest surge (e.g., interest surge 250 or interest surge 350) represented by a portion of the user submissions accessed in operation 510 (e.g., the portion of the total user submissions 210 submitted within the time period 290).

Operation 622 may be performed as part of operation 621. In operation 622, the trend module 420 determines that the portion of the user submissions is published within a threshold period of time (e.g., time period 290). For example, the threshold period of time may be an hour, a day, a weekend, a week, a month, a quarter, a year, or a period of multiple years. Accordingly, the trend module 420 may detect the interest surge 250 as an uptick in the product-related submissions 220, an uptick in the positive ratings 240, or any suitable combination thereof. As another example, the trend module 420 may detect the interest surge 350 as a downturn in the product-related submissions 220, a drop in the positive ratings 240, or any suitable combination thereof.

In operation 623, the trend module 420 accesses historical data from the social network server 120. As noted above, the social network server 120 may correspond to the social network service provided by the social network service provider 122 to one or more users of the social network service. For example, the historical data may be or include user submissions submitted to the social network server 120 prior to the time period 290 (e.g., user submissions from prior months, prior quarters, or prior years).

According to various example embodiments, the historical data may indicate another topical trend (e.g., a further topical trend), and this other topical trend may be preceded by another interest surge (e.g., a further interest surge). Moreover, this other interest surge may be represented by another portion (e.g., a further portion) of the user submissions (e.g., total user submissions 210) published by the social network service provided by the social network service provider 122. In such a manner, the trend module 420 may access information that indicates the topical trend (e.g., topical trend 230 or topical trend 330) is a recurring phenomenon (e.g., an annual or biannual rise or fall in interest) with respect to the product discussed above with respect to operation 530.

In operation 625, the trend module 420 identifies the other topical trend (e.g., the further topical trend), the other interest surge (e.g., the further interest surge), or both, represented in the historical data accessed in operation 623. The trend module 420 may perform operation 625 based on some or all of the historical data accessed in operation 623 (e.g., based on the further portion of the user submissions).

In operation 627, the trend module 420 compares the interest surge (e.g., interest surge 250 or interest surge 350) identified in operation 621 to the historical data accessed in operation 623, to the other topical trend identified in operation 625, to the other interest surge identified in operation 625, or to any suitable combination thereof. In such a manner, the trend module 420 may identify the topical trend (e.g., topical trend 230 or topical trend 330) discussed above with respect to operation 530 as a recurring phenomenon (e.g., a quarterly, annual, or try annual rise or fall in interest) with respect to the product discussed above with respect to operation 530.

As shown in FIG. 7, the method 500 may include one or more of operations 731, 733, 735, 741, 745, or 750. One or more of operations 731, 733, and 735 may be performed as part (e.g., a precursor task, a subroutine, or a portion) of operation 530, in which the product module 430 determines that the product corresponds to the topical trend (e.g., topical trend 230 or topical trend 330) identified in operation 520.

In operation 731, the product module 430 determines that the topical trend identified in operation 520 indicates an increase (e.g., a rise) of interest in the product, which may be a new product in the inventory. As used herein, a “new product” is a product of which the quantity of the product represented by the value (e.g., the scalar value) in the inventory is a default quantity (e.g., a default scalar value). For example, the inventory may be implemented with a rule that specifies a default value of 100 units (e.g., 100 pieces or 100 items) for every new product added to the inventory. Such a rule may have the effect of causing a default quantity of a new product to be ordered (e.g., as an initial batch of products) in response to the new product being added to (e.g., newly tracked in) the inventory.

In operation 733, the product module 430 determines that the topical trend identified in operation 520 indicates an increase (e.g., rise of interest in the product, which may be an old product in the inventory. As used herein, an “old product” is a product of which the quantity of the product represented by the value (e.g., the scalar value) in the inventory is a previously reduced quantity (e.g., a previously reduced scalar value). As an example, the inventory may be implemented with a rule that specifies a twenty percent (20%) reduction in the quantity of a product (e.g., from 100 units to 80 units) in response to sales of the product dropping below a threshold frequency (e.g., 10 units per week). Such a rule may have the effect of causing smaller quantities of an existing (e.g., old) product to be ordered in response to slowing sales.

In operation 735, the product module 430 determines that the topical trend (e.g., topical trend 230 or topical trend 330) determined in operation 520 indicates a reduction of interest in the product. For example, the product module 430 may determine that the topical trend indicates a reduction in interest paid to the product by at least some users of the social network service provided by the social network service provider 122.

One or more of operations 741 and 745 may be performed as part (e.g., a precursor task, a subroutine, or a portion) of operation 540, in which the inventory module 440 adjusts the value (e.g., the scalar value) that represents the quantity of the product in the inventory. In operation 741, the inventory module 440 adjusts the value by reducing the value (e.g., the scalar value) in response to performance of operation 731 or operation 733 by the product module 430. For example, the inventory module 440 may reduce the value in response to the topical trend (e.g., topical trend 230 or topical trend 20 330) indicating a reduction in attention paid to the product by at least some users of the social network service provided by the social network service provider 122.

In operation 745, the inventory module 440 adjusts the value by increasing the value (e.g., the scalar value) in response to the performance of operation 735 by the product module 430. As an example, the inventory module 440 may increase the value in response to the topical trend (e.g., topical trend 230 or topical trend 330) indicating an increase in attention paid to the product by least some users of the social network service provided by the social network service provider 122.

Operation 750 may be performed in response to performance of operation 540, in which the inventory module 440 adjusts the value that represents the quantity of the product in the inventory (e.g., stored in the database 115). In operation 750, the order module 450 generates an order for a quantity of the product (e.g., a further quantity of the product). The generating of the order may be based on the adjusted value (e.g., the adjusted scalar value) discussed above with respect to operation 540. For example, supposing that the inventory module 440 performs operation 540 by adjusting the value from 1300 units to 1500 units, the order module 450 may perform operation 750 by generating an order for 200 units (e.g., 200 pieces or 200 items) of the product.

According to various example embodiments, one or more of the methodologies described herein may facilitate inventory adjustment based on social network data. Moreover, one or more of the methodologies described herein may facilitate automatic ordering of additional products in response to inventory adjustment based on social network data. Hence, one or more the methodologies described herein may facilitate automated detection of surges in interest and topical trends and automated responses thereto with respect to an inventory of products.

When these effects are considered in aggregate, one or more of the methodologies described herein may obviate a need for certain efforts or resources that otherwise would be involved in adjusting an inventory of products in response to dynamically changing rises and falls in interest among users of the social networking service. Efforts expended by a merchant or manufacturer of a product in identifying topical trends and responding to topical trends may be reduced by one or more of the methodologies described herein. Computing resources used by one or more machines, databases, or devices (e.g., within the network environment 100) may similarly be reduced. Examples of such computing resources include processor cycles, network traffic, memory usage, data storage capacity, power consumption, and cooling capacity.

FIG. 8 is a block diagram illustrating components of a machine 800, according to some example embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system and within which instructions 824 (e.g., software) for causing the machine 800 to perform any one or more of the methodologies discussed herein may be executed. In alternative embodiments, the machine 800 operates as a standalone device or may be connected (e.g., networked) to other machines. In a networked deployment, the machine 800 may operate in the capacity of a server machine or a client machine in a server-client network environment, or as a peer machine in a peer-to-peer (or distributed) network environment. The machine 800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 824, sequentially or otherwise, that specify actions to be taken by that machine. Further, while only a single machine is illustrated, the term “machine” shall also be taken to include a collection of machines that individually or jointly execute the instructions 824 to perform any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The machine 800 may further include a graphics display 810 (e.g., a plasma display panel (PDP), a light emitting diode (LED) display, a liquid crystal display (LCD), a projector, or a cathode ray tube (CRT)). The machine 800 may also include an alphanumeric input device 812 (e.g., a keyboard), a cursor control device 814 (e.g., a mouse, a touchpad, a trackball, a joystick, a motion sensor, or other pointing instrument), a storage unit 816, a signal generation device 818 (e.g., a speaker), and a network interface device 820.

The storage unit 816 includes a machine-readable medium 822 on which is stored the instructions 824 (e.g., software) embodying any one or more of the methodologies or functions described herein. The instructions 824 may also reside, completely or at least partially, within the main memory 804, within the processor 802 (e.g., within the processor's cache memory), or both, during execution thereof by the machine 800. Accordingly, the main memory 804 and the processor 802 may be considered as machine-readable media. The instructions 824 may be transmitted or received over a network 826 (e.g., network 190) via the network interface device 820.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 822 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 800), such that the instructions, when executed by one or more processors of the machine (e.g., processor 802), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The following descriptions define various example embodiments of methods and systems (e.g., apparatus) discussed herein:

1. A method comprising:

accessing a set of user submissions published by a social network service, the set of user submissions being accessed from a social network server that provides at least part of the social network service;
identifying a topical trend from the set of user submissions accessed from the social network server;
determining that a product corresponds to the topical trend identified from the set of user submissions accessed from the social network server; and
adjusting a scalar value representative of a quantity of the product within an inventory based on the topical trend identified from the set of user submissions accessed from the social network server, the adjusting of the quantity of the product being performed by a processor of a machine.

2. The method of description 1, wherein:

the accessing of the set of user submissions published by the social network service includes making a request to an application programming interface of the social network service and transmitting the request to the social network server.

3. The method of description 1 or description 2, wherein:

the accessing of the set of user submissions includes accessing a webpage that references the product and presents at least some of the user submissions.

4. The method of any of descriptions 1-3, wherein:

the accessing of the set of user submissions published by the social network service includes accessing a plurality of positive ratings pertinent to the product.

5. The method of description 4, wherein:

a positive rating among the plurality of positive ratings is a like indicator that indicates that a user of the social network service likes the product.

6. The method of description 4 or description 5, wherein:

a positive rating among the plurality of positive ratings is indicative of a positive sentiment toward at least one of: a product webpage that describes the product, a news article that mentions the product, a seller webpage that references a seller of the product, a manufacturer webpage that references a manufacturer of the product, or a celebrity webpage that associates a celebrity with the product.

7. The method of any of descriptions 4-6, wherein:

a positive rating among the plurality of positive ratings is indicative of a positive sentiment toward at least one of: a comment that references the product, a question that references the product, an answer that references the product, or a link to a webpage that references the product.

8. The method of any of descriptions 1-7, wherein:

the identifying of the topical trend from the set of user submissions includes identifying an interest surge represented by a portion of the set of user submissions.

9. The method of description 8, wherein:

the identifying of the interest surge includes determining that the portion of the set of user submissions is published within a threshold period of time.

10. The method of description 8 or description 9, wherein:

the identifying of the topical trend from the set of user submissions includes comparing the interest surge represented by the portion of the set of user submissions with historical data that indicates a further topical trend being preceded by a further interest surge represented by a further portion of a further set of user submissions published by the social network service.

11. The method of description 10 further comprising:

accessing the historical data from the social network server that corresponds to the social network service; and
identifying the further topical trend and the further interest surge based on the historical data.

12. The method of any of descriptions 1-11, wherein:

the determining that the product corresponds to the topical trend includes determining that the topical trend indicates an increase of interest in a new product of which the quantity represented by the scalar value is a default quantity.

13. The method of any of descriptions 1-12, wherein:

the determining that the product corresponds to the topical trend includes determining that the topical trend indicates an increase of interest in an old product of which the quantity represented by the scalar value has been previously reduced from a former quantity.

14. The method of any of descriptions 1-13, wherein:

the adjusting of the scalar value based on the topical trend includes reducing the scalar value in response to the topical trend indicating a reduction in attention paid to the product by at least some users of the social network service.

15. The method of any of descriptions 1-14, wherein:

the adjusting of the scalar value based on the topical trend includes increasing the scalar value in response to the topical trend indicating an increase in attention paid to the product by at least some users of the social network service.

16. The method of any of descriptions 1-15 further comprising:

generating an order for a further quantity of the product based on the adjusted scalar value that represents the quantity of the product.

17. A non-transitory machine-readable storage medium comprising instructions that, when executed by one or more processors of a machine, cause the machine to perform operations comprising:

accessing a set of user submissions published by a social network service, the set of user submissions being accessed from a social network server that provides at least part of the social network service;
identifying a topical trend from the set of user submissions accessed from the social network server;
determining that a product corresponds to the topical trend identified from the set of user submissions accessed from the social network server; and
adjusting a scalar value representative of a quantity of the product within an inventory based on the topical trend identified from the set of user submissions accessed from the social network server, the adjusting of the quantity of the product being performed by the one or more processors of the machine.

18. The non-transitory machine-readable storage medium of description 17, wherein the operations further comprise:

generating an order for a further quantity of the product based on the adjusted scalar value that represents the quantity of the product.

19. A system comprising:

an access module configured to access a set of user submissions published by a social network service, the set of user submissions being accessed from a social network server that provides at least part of the social network service;
a trend module configured to identify a topical trend from the set of user submissions accessed from the social network server;
a product module configured to determine that a product corresponds to the topical trend identified from the set of user submissions accessed from the social network server; and
a processor configured by an inventory module to adjust a scalar value representative of a quantity of the product within an inventory based on the topical trend identified from the set of user submissions accessed from the social network server.

20. The system of description 19 further comprising:

an order module configured to generate an order for a further quantity of the product based on the adjusted scalar value that represents the quantity of the product.

What is claimed is:

1. A system comprising:
an access module configured to access a set of user submissions published by a social network service,
the set of user submissions being accessed from a social network server that provides at least part of the social network service;
a trend module configured to identify a topical trend from the set of user submissions accessed from the social network server;
a product module configured to determine that a product corresponds to the topical trend identified from the set of user submissions accessed from the social network server; and
a processor configured by an inventory module to adjust a scalar value representative of a quantity of the product within an inventory based on the topical trend identified from the set of user submissions accessed from the social network server.

2. The system of claim 1 further comprising:
an order module configured to generate an order for a further quantity of the product based on the adjusted scalar value that represents the quantity of the product.

3. A method comprising:
accessing a set of user submissions published by a social network service, the set of user submissions being accessed from a social network server that provides at least part of the social network service;
identifying a topical trend from the set of user submissions accessed from the social network server;
determining that a product corresponds to the topical trend identified from the set of user submissions accessed from the social network server; and
adjusting a scalar value representative of a quantity of the product within an inventory based on the topical trend identified from the set of user submissions accessed from the social network server,
the adjusting of the quantity of the product being performed by a processor of a machine.

4. The method of claim 3, wherein:
the accessing of the set of user submissions published by the social network service includes making a request to an application programming interface of the social network service and transmitting the request to the social network server.

5. The method of claim 3, wherein:
the accessing of the set of user submissions includes accessing a webpage that references the product and presents at least some of the user submissions.

6. The method of claim 3, wherein:
the accessing of the set of user submissions published by the social network service includes accessing a plurality of positive ratings pertinent to the product.

7. The method of claim 6, wherein:
a positive rating among the plurality of positive ratings is a like indicator that indicates that a user of the social network service likes the product.

8. The method of claim 6, wherein:
a positive rating among the plurality of positive ratings is indicative of a positive sentiment toward at least one of:
a product webpage that describes the product,
a news article that mentions the product,
a seller webpage that references a seller of the product,
a manufacturer webpage that references a manufacturer of the product, or
a celebrity webpage that associates a celebrity with the product.

9. The method of claim 6, wherein:
a positive rating among the plurality of positive ratings is indicative of a positive sentiment toward at least one of:
a comment that references the product,
a question that references the product,
an answer that references the product, or
a link to a webpage that references the product.

10. The method of claim 3, wherein:
the identifying of the topical trend from the set of user submissions includes identifying an interest surge represented by a portion of the set of user submissions.

11. The method of claim 10, wherein:
the identifying of the interest surge includes determining that the portion of the set of user submissions is published within a threshold period of time.

12. The method of claim 10, wherein:
the identifying of the topical trend from the set of user submissions includes comparing the interest surge represented by the portion of the set of user submissions with historical data that indicates a further topical trend being preceded by a further interest surge represented by a further portion of a further set of user submissions published by the social network service.

13. The method of claim 12 further comprising:
accessing the historical data from the social network server that corresponds to the social network service; and
identifying the further topical trend and the further interest surge based on the historical data.

14. The method of claim 3, wherein:
the determining that the product corresponds to the topical trend includes determining that the topical trend indicates an increase of interest in a new product of which the quantity represented by the scalar value is a default quantity.

15. The method of claim 3, wherein:
the determining that the product corresponds to the topical trend includes determining that the topical trend indicates an increase of interest in an old product of which the quantity represented by the scalar value has been previously reduced from a former quantity.

16. The method of claim 3, wherein:
the adjusting of the scalar value based on the topical trend includes reducing the scalar value in response to the topical trend indicating a reduction in attention paid to the product by at least some users of the social network service.

17. The method of claim 3, wherein:
the adjusting of the scalar value based on the topical trend includes increasing the scalar value in response to the topical trend indicating an increase in attention paid to the product by at least some users of the social network service.

18. The method of claim 3 further comprising:
generating an order for a further quantity of the product based on the adjusted scalar value that represents the quantity of the product.

19. A non-transitory machine-readable storage medium comprising instructions that, when executed by one or more processors of a machine, cause the machine to perform operations comprising:
accessing a set of user submissions published by a social network service, the set of user submissions being accessed from a social network server that provides at least part of the social network service;
identifying a topical trend from the set of user submissions accessed from the social network server;
determining that a product corresponds to the topical trend identified from the set of user submissions accessed from the social network server; and
adjusting a scalar value representative of a quantity of the product within an inventory based on the topical trend identified from the set of user submissions accessed from the social network server,
the adjusting of the quantity of the product being performed by the one or more processors of the machine.

20. The non-transitory machine-readable storage medium of claim 19, wherein the operations further comprise:
generating an order for a further quantity of the product based on the adjusted scalar value that represents the quantity of the product.
